(19) United States
(12) Patent Application Publication
(10) Pub. No.: US 2025/0199529 A1
(43) Pub. Date: Jun. 19, 2025

(54) TRAFFIC CONTROL APPARATUS, TRAFFIC CONTROL SYSTEM, AND TRAFFIC CONTROL METHOD

(71) Applicant: NEC CORPORATION, Tokyo (JP)

(72) Inventors: Yasuhiro MIZUKOSHI, Tokyo (JP); Masayuki SAKATA, Tokyo (JP); Takashi YAMANE, Tokyo (JP); Takanori IWAI, Tokyo (JP); Koichi NIHEI, Tokyo (JP); Kosei KOBAYASHI, Tokyo (JP); Yusuke SHINOHARA, Tokyo (JP)

(73) Assignee: NEC CORPORATION, Tokyo (JP)

(21) Appl. No.: 19/065,210

(22) Filed: Feb. 27, 2025

Related U.S. Application Data
(63) Continuation of application No. 17/802,630, filed on Aug. 26, 2022.

(51) Int. Cl. G05D 1/00; G06V 20/59; G06V 40/10

(52) U.S. Cl. CPC G05D 1/221; G06V 20/593; G06V 40/103

(57) ABSTRACT

A traffic control apparatus, a traffic control system, and a traffic control method that can facilitate an operation of an autonomous driving vehicle are provided. A traffic control apparatus includes analysis means for analyzing a state of a vehicle based on information about the vehicle including an autonomous driving function, specifying means for specifying a control policy, which is predetermined control to be transmitted to the vehicle, based on the analyzed state of the vehicle and remote control means for controlling driving of the vehicle based on the specified control policy.

This application is a Continuation of application Ser. No. 17/802,630, filed on Aug. 26, 2022, which is a National Stage Entry of PCT/JP2020/013403 filed on Mar. 25, 2020, the contents of all of which are incorporated herein by reference, in their entirety.

### TECHNICAL FIELD

The present disclosure relates to a traffic control apparatus, a traffic control system, and a traffic control method.

### BACKGROUND ART

In the Lv4 generation and above of autonomous driving vehicles, it is assumed that there is no driver inside the vehicles. Therefore, it is desirable to construct a so-called watching system in which a remote monitoring person is assigned to watch over the vehicle from a distance, so that any abnormality in the vehicle can be handled.

For example, Patent Literature 1 discloses a vehicle remote control support system including a vehicle and a control center. The vehicle can travel in three modes, an autonomous driving mode, a manual driving mode, and a remote control mode, and the control center can remotely operate the vehicle. In the vehicle remote operation support system described in Patent Literature 1, when the vehicle judges that the autonomous driving is difficult, the vehicle requests an operator at a traffic control center to perform a remote operation.

Patent Literature 2 discloses a remote control apparatus in which an operator intervenes to remotely control an autonomous driving vehicle. In Patent Literature 2, it is described that the remote control apparatus of Patent Literature 2 is remotely controlled by a traveling locus or the like associated with similar data in addition to vehicle information of the autonomous driving vehicle.

Patent Literature 3 discloses an autonomous driving control system for controlling autonomous driving of a vehicle from the outside of the vehicle. In Patent Literature 3, it is described that, in the autonomous driving control system, when an occurrence of a predetermined situation is detected by a sensor unit of the vehicle, the autonomous driving control corresponding to the predetermined situation is executed in preference to external control.

Patent Literature 4 discloses a management apparatus for managing a plurality of autonomous driving vehicles and a plurality of remote drivers, where the number of the remote drivers is less than the number of the autonomous driving vehicles. In the management apparatus of Patent Literature 4, a remote driver who is on standby is assigned as a remote driver of an autonomous driving vehicle that needs to be driven remotely.

### CITATION LIST

### Patent Literature

Patent Literature 1: Japanese Unexamined Patent Application Publication No. 2019-191982
Patent Literature 2: Japanese Unexamined Patent Application Publication No. 2019-185280
Patent Literature 3: Japanese Unexamined Patent Application Publication No. 2019-106674
Patent Literature 4: Japanese Unexamined Patent Application Publication No. 2018-142265

### SUMMARY OF INVENTION

### Technical Problem

In Patent Literature 1 to 4, an operator (a remote monitoring person) on the traffic control side remotely controls a vehicle to be remotely controlled.

The remote monitoring person needs to pay close attention to the vehicle in his/her charge. Therefore, in order to operate a plurality of autonomous driving vehicles, it is necessary to increase the number of remote monitoring persons. When a remote monitoring person is remotely operating an autonomous driving vehicle, the remote monitoring person is forced to interrupt the operation of other autonomous driving vehicles. That will disrupt operations of autonomous driving vehicles.

An object of the present disclosure is to provide a traffic control apparatus, a traffic control system, and a traffic control method that can facilitate an operation of an autonomous driving vehicle.

### Solution to Problem

In an example aspect of the present disclosure, a traffic control apparatus includes: analysis means for analyzing a state of a vehicle based on information about the vehicle including an autonomous driving function; specifying means for specifying a control policy based on the analyzed state of the vehicle, the control policy being predetermined control to be transmitted to the vehicle; and remote control means for controlling driving of the vehicle based on the specified control policy.

In another example aspect of the present disclosure, a traffic control system includes a vehicle that can be autonomously driven, a traffic control center configured to remotely control the vehicle. The vehicle includes a sensor configured to detect information about the vehicle and vehicle control means for controlling autonomous driving based on the information detected by the sensor. The traffic control center includes: analysis means for analyzing a state of the vehicle based on the information received from the vehicle via a network; specifying means for specifying a control policy based on the analyzed state of the vehicle, the control policy being predetermined control to be transmitted to the vehicle; and remote control means for controlling driving of the vehicle based on the specified control policy.

In another example aspect of the present disclosure, a traffic control method includes: analyzing a state of a vehicle based on information about the vehicle including an autonomous driving function; specifying a control policy based on the analyzed state of the vehicle, the control policy being predetermined control to be transmitted to the vehicle; and controlling driving of the vehicle based on the specified control policy.

### Advantageous Effects of Invention

According to the present disclosure, it is possible to provide a vehicle traffic control system, a vehicle traffic control center, and a vehicle traffic control method that can facilitate the operation of an autonomous driving vehicle.

### BRIEF DESCRIPTION OF DRAWINGS

FIG. 1 is a configuration diagram showing an example of a traffic control system according to a first example embodiment;

FIG. 2 is a configuration diagram showing an example of the traffic control apparatus according to the first example embodiment;

FIG. 3 is a flowchart showing an example of an operation of a vehicle according to the first example embodiment;

FIG. 4 is a flowchart showing an example of a traffic control method of the traffic control apparatus according to the first example embodiment;

FIG. 5 is a sequence diagram showing an example of the traffic control method of the traffic control system according to the first example embodiment;

FIG. 6 is a configuration diagram showing an example of a traffic control system according to a second example embodiment;

FIG. 7 is a configuration diagram showing an example of the traffic control apparatus according to the second example embodiment;

FIG. 8 is a flowchart showing an example of an operation of a vehicle according to the second example embodiment;

FIG. 9 is a flowchart showing an example of a traffic control method of the traffic control apparatus according to the second example embodiment; and

FIG. 10 is a sequence diagram showing an example of the traffic control method of the traffic control system according to the second example embodiment.

### EXAMPLE EMBODIMENT

Example embodiments will be described below with reference to the drawings. For clarity of explanation, the following description and drawings have been omitted and simplified as appropriate. In each of the drawings, the same elements are denoted by the same reference signs, and repeated explanations are omitted if necessary.

### First Example Embodiment

A traffic control system according to a first example embodiment will be described. First, an overview of the traffic control system will be described. Next, a vehicle and a traffic control apparatus constituting the traffic control system will be described. After that, a traffic control method using the traffic control system will be described.

### <Traffic Control System>

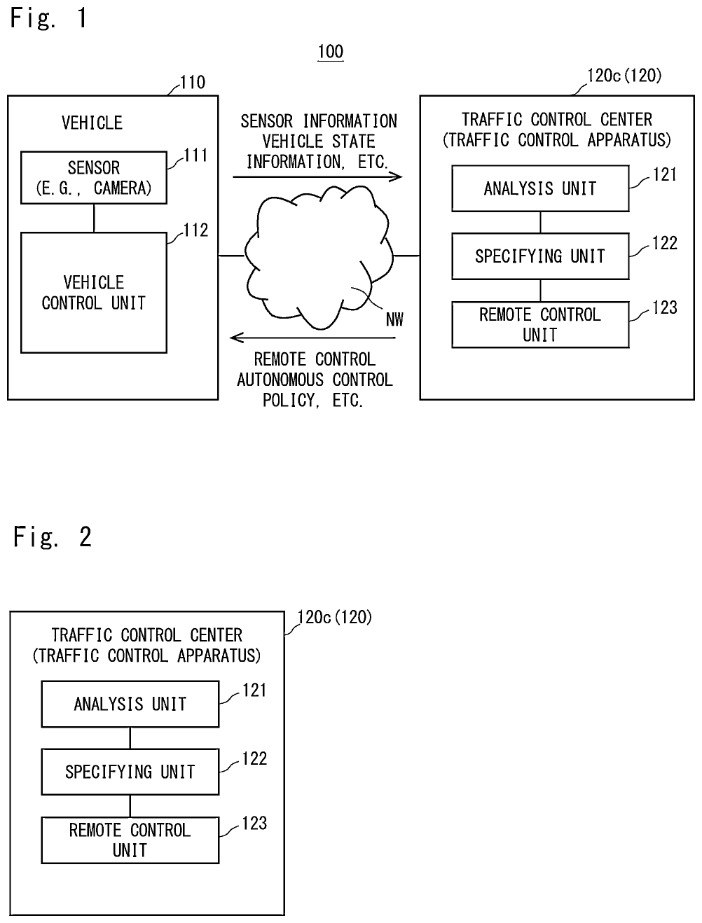

First, a traffic control system according to the first example embodiment will be described. FIG. 1 is a configuration diagram showing an example of a traffic control system according to the first example embodiment. As shown in FIG. 1, a traffic control system 100 includes a vehicle 110 and a traffic control center 120c.

The traffic control system 100 is a system for controlling the vehicle 110 having an autonomous driving function. In the traffic control system 100 according to this example embodiment, the traffic control center 120c receives sensor information and information such as a state of the vehicle 110 from the vehicle 110 via a network NW. The traffic control center 120c analyzes the state of the vehicle 110 based on the received information about the vehicle 110, and controls the vehicle 110 according to a result of the analysis. For example, the traffic control center 120c remotely controls the vehicle 110. Alternatively, the traffic control center 120c controls the vehicle 110 to control itself by transmitting an autonomous driving control policy.

The traffic control center 120c includes a traffic control apparatus 120. The vehicle 110 and the traffic control apparatus 120 constituting the traffic control system 100 will be described below.

### <Vehicle>

The vehicle 110 has an autonomous driving function that enables the vehicle 110 to be autonomously driven. The vehicle 110 having the autonomous driving function is, for example, an autonomous driving vehicle such as a private car, a taxi, a bus, or a truck. The vehicle 110 having the autonomous driving function is not limited to an autonomous driving vehicle traveling on a road, and may instead be a train or the like traveling on a railway. The vehicle 110 includes a sensor 111 and a vehicle control unit 112.

The sensor 111 detects information about the vehicle 110. The sensor 111 may be, for example, a camera, a speedometer, a rudder angle indicator, a GPS (Global Positioning System) receiver, or the like. The camera captures an image of an area in front of, around, or inside the vehicle 110. The speedometer measures a speed of the vehicle 110. The rudder angle indicator detects a course direction of the vehicle 110. The GPS receiver detects the position of the vehicle 110. The sensor 111 is not limited to a camera, a speedometer, a rudder angle indicator, a GPS receiver, etc., as long as it detects the information about the vehicle 110.

The sensor 111 outputs the detected information about the vehicle 110 to the vehicle control unit 112. The sensor 111 transmits the detected information about the vehicle 110 to the traffic control center 120c via the network NW. The detected information about the vehicle 110 includes, for example, video information about the area in the front of the vehicle 110, video information about the inside of the vehicle, and sensor information such as a speed, a course direction, and a position. The detected information about the vehicle 110 includes vehicle state information such as a traveling state of the vehicle 110 and a peripheral situation of the vehicle 110 derived from the sensor information.

The vehicle control unit 112 controls the vehicle 110. Therefore, the vehicle control unit 112 functions as vehicle control means. The vehicle control unit 112 is connected to an ECU (Electronic Control Unit) and controls the ECU in order to control the vehicle 110. The vehicle control unit 112 may be composed of hardware including a microcomputer having a CPU (Central Processing Unit), a ROM (Read Only Memory), a RAM (Random Access Memory), an interface unit (I/F), and the like. The CPU performs analysis processing, control processing, and the like of the state of the vehicle 110 based on the information about the vehicle 110. The ROM stores an analysis program, a control program and the like executed by the CPU. The RAM stores various data pieces such as the information about the vehicle 110. The interface unit (I/F) inputs and outputs signals to and from an external device such as a network NW. The CPU, the ROM, the RAM, and the interface are connected to each other via data buses or the like.

The vehicle control unit 112 controls autonomous driving based on the information about the vehicle 110 detected by the sensor 111. For example, the vehicle control unit 112 controls the vehicle 110 to stop when the sensor 111 detects an obstacle in front of the vehicle 110. When the sensor 111 detects the speed of the vehicle 110 greater than or equal to a speed limit, the vehicle control unit 112 controls the vehicle to decelerate.

The vehicle control unit 112 controls the vehicle 110 based on the control policy output from the traffic control center 120c. The control policy is predetermined control transmitted to the vehicle 110. The control policy includes an autonomous control policy and a remote control policy. The autonomous control policy is for controlling the vehicle 110 to be autonomously driven. The remote control policy is for controlling the vehicle 110 to be remotely driven. For example, if the vehicle control unit 112 receives the autonomous control policy for causing the vehicle 110 to be autonomously driven from the traffic control center 120c, it controls the autonomous driving of the vehicle 110 based on the information about the vehicle 110.

On the other hand, if the vehicle control unit 112 receives the remote control policy for remotely controlling the vehicle 110 from the traffic control center 120c, it controls the vehicle 110 based on the remote control from the traffic control center 120c. The control policy may include rules for autonomous driving, etc., in addition to the autonomous control policy and the remote control policy. The rules for autonomous driving include, for example, driving control policies such as speed limit compliance.

### <Traffic Control Apparatus>

Next, the traffic control apparatus 120 will be described. FIG. 2 is a configuration diagram showing an example of the traffic control apparatus 120 according to the first example embodiment. As shown in FIG. 2, the traffic control apparatus 120 provided in the traffic control center 120c is a stand-alone device, and may be incorporated into the traffic control system 100 as shown in FIG. 1.

The traffic control apparatus 120 may be composed of hardware including a microcomputer composed of a CPU, a RAM, an interface unit, and the like and a general-purpose computer composed of a GPU, an FPGA, an HDD as a storage, an SSD, and the like. The CPU, GPU, FPGA, and the like perform analysis processing, control processing and the like based on the information about the vehicle 110. The ROM, HDD, SSD, and the like store an analysis program, a control program, etc., executed by, for example, a CPU. The RAM, HDD, SSD, etc., store various data such as the information about the vehicle 110. The interface unit (I/F) inputs and outputs signals to and from an external device such as the network NW. The CPU, GPU, FPGA, ROM, RAM, HDD, SSD, and interface units are connected to each other via a data bus, connection wiring, or the like.

As shown in FIGS. 1 and 2, the traffic control apparatus 120 controls the vehicle 110 having the autonomous driving function that enables the vehicle 110 to be autonomously driven. The traffic control apparatus 120 includes an analysis unit 121, a specifying unit 122, and a remote control unit 123. The analysis unit 121, the specifying unit 122, and the remote control unit 123 have functions as analysis means, specifying means, and remote control means, respectively.

The analysis unit 121 analyzes the state of the vehicle 110 based on the information about the vehicle 110 having the autonomous driving function. The information about the vehicle 110 is, for example, information detected by the sensor 111 provided in the vehicle 110. The analysis unit 121 receives the information detected by the sensor 111 via the network NW.

The analysis unit 121 analyzes the state of the vehicle 110 based on the information received from the vehicle 110. The state of the vehicle 110 includes, for example, a state where a risk degree of the vehicle 110 is high and a state where an emergency degree of the vehicle 110 is high. The state of the vehicle 110 includes a state in which autonomous control is possible and a state in which remote control is desirable. The analysis unit 121 may set the state where the risk degree is high or the state where the emergency degree is high in advance.

For example, among the sensors 111, a camera installed in front of the vehicle 110 acquires video information about the area in front of the vehicle 110. Thus, information about the vehicle 110 includes video information about the area the front of the vehicle 110. When the video information about the area in front of the vehicle 110 is transmitted as the information about the vehicle 110, the analysis unit 121 three-dimensionally recognizes a traffic environment such as a road, an intersection, a traffic sign, and a traffic signal in front of the vehicle 110 based on the video information about the area in the front of the vehicle 110.

The analysis unit 121 recognizes a peripheral vehicle(s) and a peripheral person(s) based on the video information about the area in front of the vehicle 110. Further, the analysis unit 121 calculates in real time the time and position until the vehicle 110 crosses the peripheral vehicle and the peripheral person at the intersection based on the video information about the area in front of the vehicle 110. Then, the analysis unit 121 analyzes, as the state of the vehicle 110, the degree of risk of a collision with the recognized peripheral vehicles or persons in the traffic environment including the recognized roads, intersections, etc. For example, the analysis unit 121 may numerically analyze the state of the risk degree of the vehicle 110.

The analysis unit 121 analyzes the risk degree of the vehicle 110 as the state of the vehicle 110 when there are many persons in the range geometrically determined according to a traveling direction of the vehicle 110 based on the video information about the area in front of the vehicle 110. For example, the analysis unit 121 may analyze that the risk degree is high when the number of persons in a predetermined geometric range is greater than or equal to a threshold value.

Among the sensors 111, a camera installed inside the vehicle 110 acquires video information inside the vehicle 110. Thus, the information about the vehicle 110 includes the video information about the inside of the vehicle 110. When the video information about the inside of the vehicle 110 is transmitted as the information about the vehicle 110, the analysis unit 121 recognizes an action of a passenger in the vehicle and a state of the passenger based on the video information about the inside of the vehicle 110. Then, the analysis unit 121 analyzes the emergency degree of the action of the passenger in the vehicle and the state of the passenger as the state of the vehicle 110. For example, the analysis unit 121 analyzes a state in which the passenger falls down or staggers as a state where the emergency degree is high. The analysis unit 121 may analyze the state of the emergency degree of the vehicle 110 by numerically calculating the number of persons falling down or the frequency of staggering.

When the vehicle 110 is a bus and the information about the vehicle 110 includes the video information about the inside of the bus, the analysis unit 121 may analyze the passengers and the postures of the passengers in the vehicle as the state of the vehicle 110. For example, the analysis unit 121 may analyze the state of the emergency degree of the vehicle 110 by numerically calculating the number of persons with canes in the bus.

In this way, the analysis unit 121 may analyze the predetermined risk degree and emergency degree of the vehicle 110 as the state of the vehicle 110.

The specifying unit 122 specifies the control policy based on the analyzed state of the vehicle 110. The control policy is predetermined control transmitted to the vehicle 110. For example, the control policy includes the autonomous control policy for controlling the vehicle 110 to be autonomously driven. The control policy also includes the remote control policy for controlling the vehicle 110 to be remotely driven.

For example, when the risk degree of the analyzed state of the vehicle 110 is greater than or equal to the predetermined risk degree or when the emergency degree of the analyzed state of the vehicle 110 is greater than or equal to the predetermined emergency degree, the specifying unit 122 specifies the control policy as the remote control policy. Specifically, the specifying unit 122 specifies the control policy as the remote control policy when the degree of risk of a collision with a peripheral vehicle or a peripheral person is greater than or equal to a predetermined threshold value. When the emergency degree of the recognized actions of the passengers and the states of the passengers in the vehicle is greater than or equal to a predetermined threshold value, the specifying unit 122 specifies the control policy as the remote control policy. The specifying unit 122 specifies the control policy as the remote control policy when a passenger in the vehicle, which is the bus, is a predetermined person prone to fall or a posture of the person is a predetermined posture prone to fall. The specifying unit 122 may specify the control policy as the remote control policy when it is considered that remote control is necessary, such as when the vehicle 110 has stopped due to another factor in the above-described situation.

On the other hand, when the analyzed state of the vehicle 110 corresponds to a predetermined risk degree or less than a predetermined emergency degree, the specifying unit 122 specifies the control policy as the autonomous control policy.

The remote control unit 123 remotely controls the driving of the vehicle 110 based on the specified control policy. For example, when the specified control policy is the autonomous control policy, the remote control unit 123 controls the vehicle 110 to be driven automatically. On the other hand, when the specified control policy is the remote control policy, the remote control unit 123 controls the vehicle 110 to be remotely controlled.

Next, a traffic control method will be described as an operation of the traffic control system 100 according to the first example embodiment. The description of the traffic control method will be divided into three parts; a description of an operation of the vehicle 110, a description of a traffic control method of the traffic control apparatus 120, and a description of a traffic control method of the traffic control system 100.

### <Vehicle Operation>

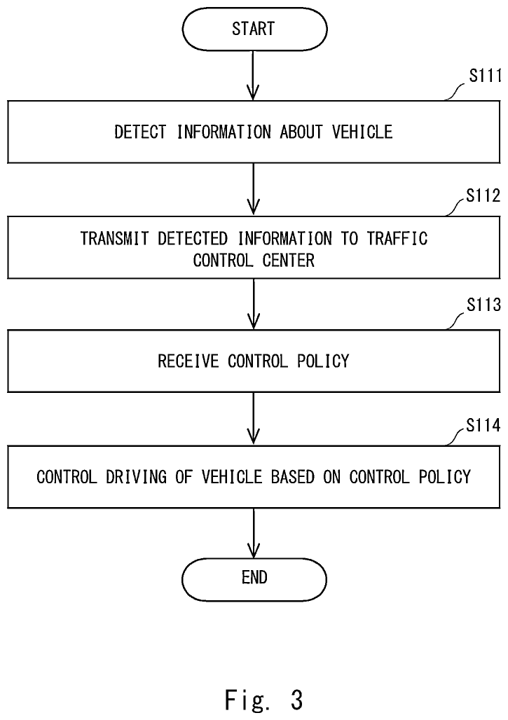

FIG. 3 is a flowchart showing an example of the operation of the vehicle 110 according to the first example embodiment. As shown in Step S111 of FIG. 3, information about the vehicle 110 is detected. For example, the sensor 111 provided in the vehicle 110 detects information about the vehicle 110 that can be autonomously driven. The information about the vehicle 110 includes, for example, video information about the area in the front of the vehicle 110, video information about the inside of the vehicle, speed, course direction, and position. If the vehicle 110 has not received the control policy, it remains in standby. When the present control policy is the autonomous control policy, the vehicle 110 continues autonomous driving based on the detected information. When the current control policy is the remote control policy, the vehicle 110 is remotely controlled by the traffic control center 120c.

Next, as shown in Step S112, the detected information is transmitted to the traffic control center 120c. Specifically, the sensor 111 transmits the information about the detected vehicle 110 to the traffic control center 120c (the traffic control apparatus 120).

Next, as shown in Step S113, the control policy is received. For example, the vehicle control unit 112 receives the control policy from the traffic control apparatus 120. If the control policy has not arrived from the traffic control apparatus 120 in Step S113, the processing may proceed to Step S114. That is, the present control policy may be maintained. As described above, the control policy may be received asynchronously in Step S113.

Next, as shown in Step S114, the driving of the vehicle 110 is controlled based on the control policy. For example, when the control policy received from the traffic control apparatus 120 is the autonomous control policy, the vehicle control unit 112 performs autonomous driving. On the other hand, when the control policy received from the traffic control apparatus 120 is the remote control policy, the vehicle control unit 112 is remotely controlled by the traffic control apparatus 120. When the vehicle control unit 112 receives a new control policy different from the control policy before receiving the new control policy, it follows with the new control policy.

### <Traffic Control Method of Traffic Control Apparatus>

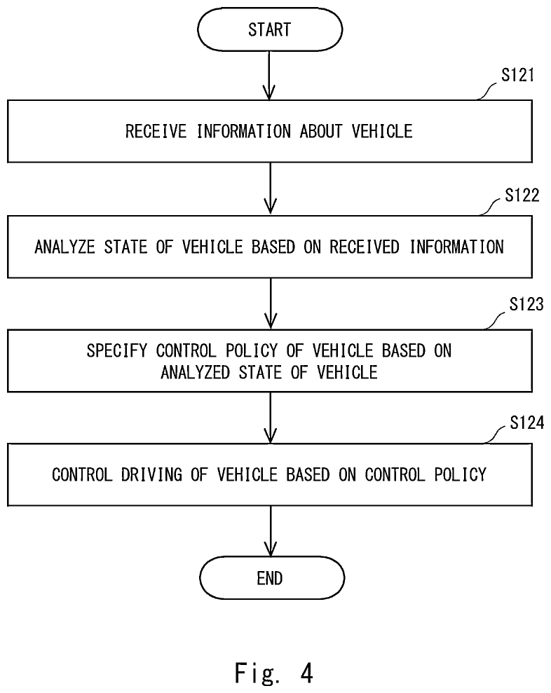

Next, the traffic control method of the traffic control apparatus 120 will be described. FIG. 4 is a flowchart showing an example of the traffic control method of the traffic control apparatus 120 according to the first example embodiment. As shown in Step S121 of FIG. 4, the traffic control apparatus 120 receives information about the vehicle 110. For example, the analysis unit 121 in the traffic control apparatus 120 receives the information about the vehicle 110 detected by the sensor 111 from the vehicle 110 via the network NW.

Next, as shown in Step S122, the state of the vehicle 110 is analyzed based on the received information. For example, the analysis unit 121 analyzes the risk degree or emergency degree of the vehicle 110 based on the received information about the vehicle 110.

Next, as shown in Step S123, the control policy of the vehicle 110 is specified based on the analyzed state of the vehicle 110. For example, the specifying unit 122 specifies the control policy of the vehicle 110 as the autonomous control policy, the remote control policy, or the like based on the analyzed risk or emergency degree of the vehicle 110. The specifying unit 122 specifies a new control policy when a state of the vehicle 110 such as the risk degree or the emergency degree changes.

Next, as shown in Step S124, the driving of the vehicle 110 is controlled based on the control policy. For example, when the control policy specified by the specifying unit 122 is the autonomous control policy, the remote control unit 123 controls the vehicle 110 to be autonomously driven. On the other hand, when the control policy specified by the specifying unit 122 is the remote control policy, the remote control unit 123 remotely control the vehicle 110.

### <Traffic Control Method of Traffic Control System>

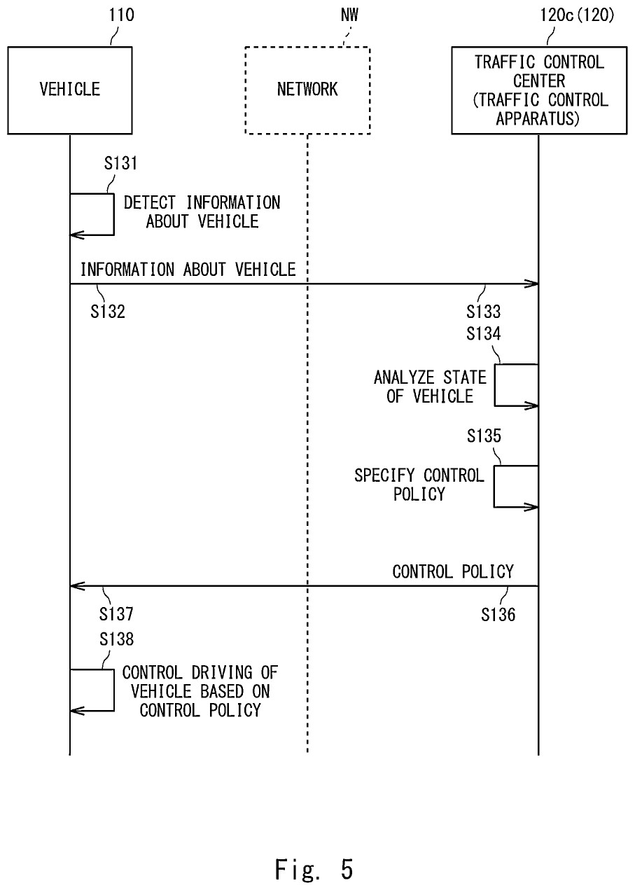

Next, the traffic control method of the traffic control system 100 will be described. FIG. 5 is a sequence diagram showing an example of the traffic control method of the traffic control system 100 according to the first example embodiment. As shown in Step S131 of FIG. 5, the vehicle 110 detects the information about the vehicle 110. For example, the vehicle 110 detects, by means of the sensor 111, the information about the vehicle 110 that can be autonomously driven. If the vehicle 110 has not received the control policy, it remains in standby. When the present control policy is the autonomous control policy, the vehicle 110 continues to be autonomously driven based on the detected information. When the present control policy is the remote control policy, the vehicle 110 is remotely controlled by the traffic control center 120c.

Next, as shown in Step S132, the vehicle 110 transmits the detected information about the vehicle 110 to the traffic control center 120c. For example, the vehicle 110 transmits the detected information about the vehicle 110 to the traffic control apparatus 120 via the network NW. Thus, as shown in Step S133, the traffic control apparatus 120 receives the information about the vehicle 110. For example, the traffic control apparatus 120 receives the information about the vehicle 110 via the network NW.

Next, as shown in Step S134, the traffic control apparatus 120 analyzes the state of the vehicle 110 based on the received information. For example, the traffic control apparatus 120 analyzes the risk or emergency degree of the vehicle 110 based on the received information about the vehicle 110.

Next, as shown in Step S135, the traffic control apparatus 120 specifies the control policy of the vehicle 110 based on the analyzed state of the vehicle 110. For example, the traffic control apparatus 120 specifies the control policy of the vehicle 110, such as the autonomous control policy or the remote control policy, based on the analyzed risk or emergency degree of the vehicle 110. The traffic control apparatus 120 specifies a new control policy when a state of the vehicle 110 such as the risk or the emergency degree changes.

Next, as shown in Step S136, the traffic control apparatus 120 transmits the control policy to the vehicle 110. For example, the traffic control apparatus 120 transmits the control policy to the vehicle 110 via the network NW. Thus, as shown in Step S137, the vehicle 110 receives the control policy from the traffic control apparatus 120 via the network NW.

Next, as shown in Step S138, the vehicle 110 controls the driving of the vehicle 110 based on the control policy. For example, when the control policy specified by the traffic control apparatus 120 is the autonomous control policy, the vehicle 110 is autonomously driven. On the other hand, when the control policy specified by the traffic control apparatus 120 is the remote control policy, the vehicle 110 is remotely controlled by the traffic control apparatus 120. When the vehicle 110 receives a new control policy different from the control policy before receiving the new control policy, it follows with the new control policy. In this manner, the vehicle 110 controls the driving of the vehicle 110 based on the control policy.

Next, the effect of this example embodiment will be described. In this example embodiment, the traffic control apparatus 120 analyzes the state of the vehicle 110 based on the information about the vehicle 110, and specifies the control policy of the vehicle 110 based on the analyzed state of the vehicle 110. Therefore, since the control of the vehicle 110 is changed according to the state of the vehicle 110, the state of the vehicle 110 can be accurately handled, and the operation of the autonomous driving vehicle can be facilitated.

For example, when the risk or emergency degree of the vehicle 110 is increased from low to medium, a speed control upper limit value of the autonomous control policy is switched from medium to low. Further, for example, when the risk or emergency degree of the vehicle 110 is high, the control is switched from the autonomous control to the remote control. Thus, since the remote control is not required in the case of the autonomous control, the number of remote monitoring persons can be reduced. Further, since the remote monitoring person can pay attention to the vehicle 110 having a high risk or emergency degree, it is possible to prevent the operation of the autonomous driving vehicle from being delayed.

### Second Example Embodiment

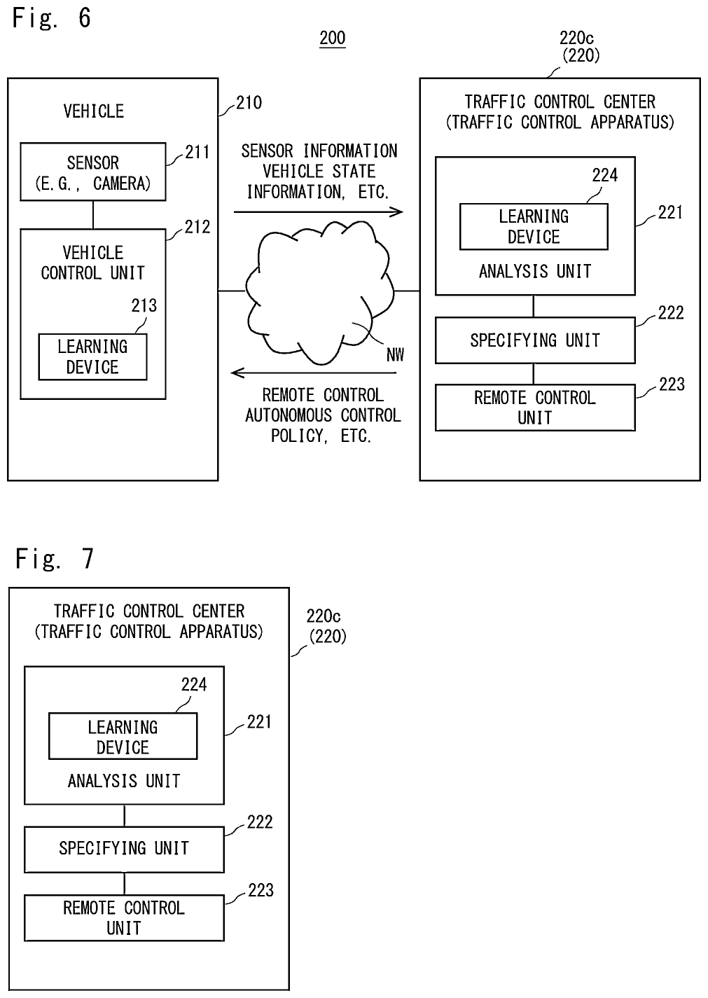

Next, a traffic control system according to a second example embodiment will be described. In a traffic control system according to this example embodiment, at least one of a vehicle and a traffic control apparatus includes a learning device. FIG. 6 is a configuration diagram showing an example of the traffic control system according to the second example embodiment. FIG. 7 is a configuration diagram showing an example of the traffic control apparatus according to the second example embodiment.

### <Traffic Control System>

As shown in FIG. 6, a traffic control system 200 according to this example embodiment includes a vehicle 210 and a control center 220c. Each component of the traffic control system 200 will be described below.

### <Vehicle>

The vehicle 210 includes a sensor 211 and a vehicle control unit 212. The vehicle control unit 212 has a function as control means for controlling the vehicle 210. The vehicle control unit 212 according to this example embodiment includes a learning device 213. The learning device 213 has a function as learning means.

The learning device 213 is, for example, AI (Artificial Intelligence). The learning device 213 learns rules for controlling the autonomous driving of the vehicle 210 based on the information about the vehicle 210. Rules that control the autonomous driving of the vehicle 210 are referred to herein as autonomous driving rules for convenience. The autonomous driving rules may include, for example, driving control such as speed limit compliance.

The learning device 213 learns the autonomous driving rule by learning the relation between the information about the vehicle 210 detected by the sensor 211 and the autonomous driving control of the vehicle 210 based on the information. The vehicle control unit 212 analyzes the state of the vehicle 210 controlled in accordance with the autonomous driving rule based on the information about the vehicle 210. The vehicle 210 transmits the detected information about the vehicle 210 and the analyzed state of the vehicle 210 to the traffic control center 120c. The configuration of the vehicle 210 other than this is the same as that of the vehicle 110 according to the first example embodiment.

### <Traffic Control Apparatus>

As shown in FIG. 7, the traffic control center 220c includes a traffic control apparatus 220. The traffic control apparatus 220 is a stand-alone device, and may be incorporated into the traffic control system 200 as shown in FIG. 6.

As shown in FIGS. 6 and 7, the traffic control apparatus 220 according to this example embodiment includes an analysis unit 221, a specifying unit 222, and a remote control unit 223. The analysis unit 221, the specifying unit 222, and the remote control unit 223 have the same functions as the analysis means, the specifying means, and the remote control means, respectively, as in the first example embodiment. The analysis unit 221 according to this example embodiment includes a learning device 224. The learning device 224 has a function as learning means.

The learning device 224 is, for example, AI. The learning device 224 learns rules for analyzing the state of the vehicle 210 based on the information about the vehicle 210. Rules for analyzing the state of the vehicle 210 are referred to herein as analysis rules for convenience. The analysis rules may include recognition priorities between a person and an obstacle in an image captured by a camera, a resolution of image processing, estimation patterns of behavior prediction from image information, and the like. The information about the vehicle 210 used for learning of the learning device 224 may be information about a plurality of vehicles 210.

The learning device 224 learns the analysis rules by learning the relation between the information about the vehicle 210 detected by the sensor 211 and the analysis result of the state of the vehicle 210 based on this information. The learning device 224 may learn the relation between the information about each vehicle 210 detected by each sensor 211 of each of the plurality of vehicles 210 and the analysis result of the state of each vehicle 210 based on the information about each vehicle. The specifying unit 222 specifies the control policy based on the state of the vehicle 210 analyzed in accordance with the analysis rules. When the learning device 213 provided in the vehicle 210 learns the autonomous driving rule, the specifying unit 222 specifies the control policy based on the analysis rules and the state of the vehicle 210 analyzed in accordance with the autonomous driving rule. The configuration of the traffic control apparatus 220 other than this is the same as that of the traffic control apparatus 120 according to the first example embodiment.

Next, a traffic control method as an operation of the traffic control system 200 according to the second example embodiment will be described. The description of the traffic control method will be divided into three parts; a description of an operation of the vehicle 210, a description of a traffic control method of the traffic control apparatus 220, and a description of a traffic control method of the traffic control system 200.

### <Operation of Vehicle>

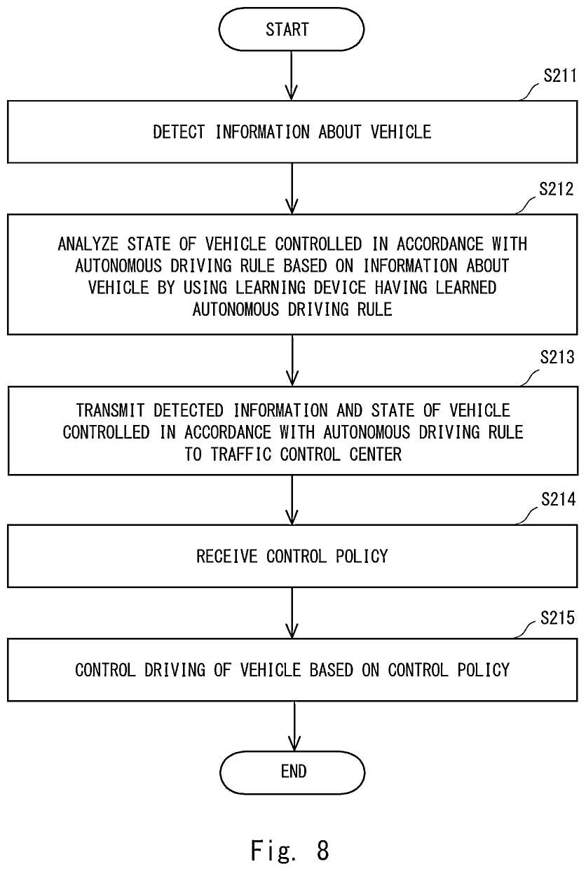

FIG. 8 is a flowchart showing an example of the operation of the vehicle 210 according to the second example embodiment. As shown in Step S211 of FIG. 8, information about the vehicle 210 is detected. For example, the sensor 211 detects the information about the vehicle 210 that can be autonomously driven.

Next, as shown in Step S212, the state of the vehicle 210 controlled in accordance with the autonomous driving rule is analyzed based on the information about the vehicle 210 by using the learning device 213 having learned the autonomous driving rule. For example, the vehicle control unit 212 analyzes that the vehicle 210 is in a state where the risk degree is high or a state where the risk degree is low in accordance with the autonomous driving rule based on the video information in front of the vehicle 210.

Next, as shown in Step S213, the detected information and the state of the vehicle 210 controlled in accordance with the autonomous driving rule are transmitted to the traffic control center 220c. Specifically, the sensor 211 transmits the video information about the area in front of the vehicle 210 to the traffic control apparatus 220. Further, the vehicle control unit 212 transmits, to the traffic control apparatus 220, that the vehicle 210 is in a state where the risk degree is high or a state where the risk degree is low based on the video information about the area in front of the vehicle 210. Here, when the video information of the sensor 211 and the state of the risk degree analyzed by the vehicle control unit 212 are separately transmitted, information may be added to cross-check them at the traffic control center.

Next, as shown in Step S214, the control policy is received. For example, the vehicle control unit 212 receives the control policy from the traffic control apparatus 220. If the control policy has not arrived from the traffic control apparatus 220 in Step S214, the processing may proceed to Step S215. As described above, the control policy may be received asynchronously in Step S214.

Next, as shown in Step S215, the driving of the vehicle 210 is controlled based on the control policy. For example, when the control policy received from the traffic control apparatus 220 is the autonomous control policy, the vehicle control unit 212 performs autonomous driving. On the other hand, when the control policy received from the traffic control apparatus 220 is the remote control policy, the vehicle control unit 212 is remotely controlled by the traffic control apparatus 220.

### <Traffic Control Method of Traffic Control Apparatus>

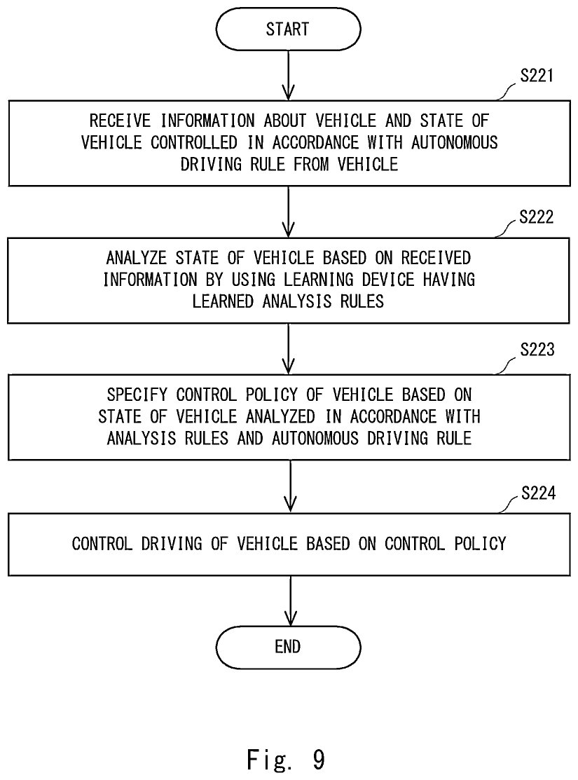

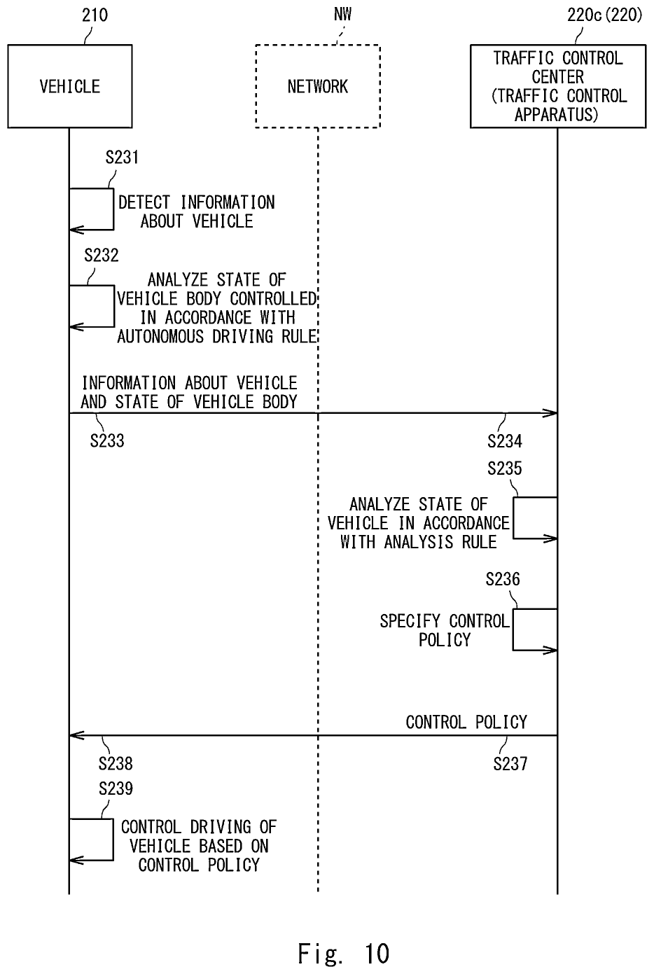

Next, the traffic control method of the traffic control apparatus 220 will be described. FIG. 9 is a flowchart showing an example of the traffic control method of the traffic control apparatus 220 according to the second example embodiment. As shown in Step S221 of FIG. 9, the information about the vehicle 210 and the state of the vehicle 210 controlled in accordance with the autonomous driving rule are received from the vehicle 210. For example, the analysis unit 221 in the traffic control apparatus 220 receives the information about the vehicle 210 detected by the sensor 211 via the network NW. The specifying unit 222 receives the state of the vehicle 210 controlled in accordance with the autonomous driving rule learned by the learning device 213 of the vehicle 210.

Next, as shown in Step S222, the state of the vehicle 210 is analyzed based on the received information by using the learning device 224 having learned the analysis rules. For example, the analysis unit 221 analyzes that the vehicle 210 is in a state where the risk degree is high or a state where the risk degree is low by using the analysis rules of the learning device 224 based on the received video information about the area in front of the vehicle 210.

Next, as shown in Step S223, the control policy of the vehicle 210 is specified based on the state of the vehicle 210 analyzed in accordance with the analysis rules and the autonomous driving rule. For example, the specifying unit 222 specifies the control policy of the vehicle 210 as the autonomous control policy or the remote control policy based on the analyzed risk or emergency degree of the vehicle 210.

Next, as shown in Step S224, the driving of the vehicle 210 is controlled based on the control policy. For example, when the control policy specified by the specifying unit 222 is the autonomous control policy, the remote control unit 223 controls the vehicle 210 to be autonomously driven. On the other hand, when the control policy specified by the specifying unit 222 is the remote control policy, the remote control unit 223 remotely controls the vehicle 210.

### <Traffic Control Method of Traffic Control System>

Next, the traffic control method of the traffic control system 200 will be described. FIG. 10 is a sequence diagram showing an example of the traffic control method of the traffic control system 200 according to the second example embodiment.

As shown in Step S231 of FIG. 10, the vehicle 210 detects the information about the vehicle 210 by means of the sensor 211.

Next, as shown in Step S232, the vehicle 210 analyzes the state of the vehicle 210 controlled in accordance with the autonomous driving rule based on the information about the vehicle 210 by using the learning device 213 having learned the autonomous driving rule. For example, the vehicle 210 may be analyzed that it is in a state where the risk degree is high or a state where the risk degree is low.

Next, as shown in Step S233, the vehicle 210 transmits the detected information and the state of the vehicle 210 controlled in accordance with the autonomous driving rule to the traffic control center 220c. Thus, as shown in Step S234, the traffic control apparatus 220 receives the information about the vehicle 210 and the state of the vehicle 210 controlled in accordance with the autonomous driving rule.

Next, as shown in Step S235, the state of the vehicle 210 is analyzed in accordance with the analysis rules based on the received information. For example, by using the learning device 224 having learned the analysis rules, the analysis unit 221 analyzes that the vehicle 210 is in a state where the risk degree is high or a state where the risk degree is low based on the received information. Next, as shown in Step S236, the control policy is specified. For example, the specifying unit 222 specifies the control policy of the vehicle 210 as the autonomous control policy or the remote control policy based on the risk or emergency degree of the vehicle 210 analyzed in accordance with the analysis rules and the autonomous driving rule.

Next, as shown in Step S237, the traffic control apparatus 220 transmits the control policy to the vehicle 210. Thus, as shown in Step S238, the vehicle 210 receives the control policy from the traffic control apparatus 220.

Next, as shown in Step S239, the vehicle 210 controls the driving of the vehicle 210 based on the control policy. For example, when the control policy specified by the traffic control apparatus 220 is the autonomous control policy, the traffic control apparatus 220 controls the vehicle 210 to be autonomously driven. Therefore, the vehicle 210 is autonomously driven. On the other hand, when the control policy specified by the traffic control apparatus 220 is the remote control policy, the traffic control apparatus 220 remotely controls the vehicle 210. Therefore, the vehicle 210 is remotely controlled by the traffic control apparatus 220. In this manner, the traffic control apparatus 220 controls the driving of the vehicle 110 based on the control policy.

According to the traffic control system 200 of this example embodiment, since the vehicle control unit 212 includes the learning device 213 for learning the autonomous driving rule, the accuracy and the determination speed of autonomous control of the vehicle 210 can be improved. The learning device 224 for learning the analysis rules included in the analysis unit 221 improves the accuracy and the analysis speed for analyzing the state of the vehicle 210. Further, since the specifying unit 222 specifies the control policy based on the state of the vehicle 210 analyzed in accordance with the analysis rules and the autonomous driving rule, the qualification of the control policy can be improved. By performing pattern learning by the learning devices 213 and 224 using AI on both the vehicle 210 side and the traffic control apparatus 220 side, it is possible to improve control accuracy and determination speed in both cases of autonomous control and remote control of the vehicle 210. Therefore, the operation of the vehicle 210 can be facilitated. Other operations and effects of the vehicle 210, the traffic control apparatus 220, and the traffic control system 200 are included in the description of the first example embodiment.

Although the first and second example embodiments have been described above, the present disclosure is not limited to the first and second example embodiments and can be suitably modified without departing from the spirit. For example, an example embodiment in which the respective configurations of the first and second example embodiments are combined is included in the scope of the technical concept. A control program for causing a computer to execute the traffic control method according to the first and second example embodiments is also included in the technical range of the first and second example embodiments.

The whole or part of the example embodiments disclosed above can be described as, but not limited to, the following supplementary notes.

### Supplementary Note 1

A traffic control apparatus comprising:
analysis means for analyzing a state of a vehicle based on information about the vehicle including an autonomous driving function;
specifying means for specifying a control policy based on the analyzed state of the vehicle, the control policy being predetermined control to be transmitted to the vehicle; and
remote control means for controlling driving of the vehicle based on the specified control policy.

### Supplementary Note 2

The traffic control apparatus according to Supplementary note 1, wherein
the analysis means comprises traffic control side learning means for learning an analysis rule for analyzing the state of the vehicle based on the information, and
the specifying means specifies the control policy based on the state of the vehicle analyzed in accordance with the analysis rule.

### Supplementary Note 3

The traffic control apparatus according to Supplementary note 2, wherein
vehicle-side learning means provided in the vehicle learns an autonomous driving rule for controlling the autonomous driving based on the information, and the specifying means specifies the control policy based on the analysis rule and the state of the vehicle analyzed in accordance with the autonomous driving rule.

### Supplementary Note 4

The traffic control apparatus according to any one of Supplementary notes 1 to 3, wherein
the control policy includes an autonomous control policy for causing the vehicle to be autonomously driven and a remote control policy for remotely controlling the vehicle, and
when the specified control policy is the autonomous control policy, the remote control means controls the vehicle to be driven autonomously, while when the specified control policy is the remote control policy, the remote control means remotely controls the vehicle.

### Supplementary Note 5

The traffic control apparatus according to Supplementary note 4, wherein
the information is video information about an area in front of the vehicle,
the analysis means analyzes, as the state of the vehicle, a risk degree of a collision with a recognized peripheral vehicle or a recognized peripheral person in a traffic environment including a recognized road and a recognized intersection, and
the specifying means specifies the control policy as a remote control policy when the risk degree is greater than or equal to a threshold value.

### Supplementary Note 6

The traffic control apparatus according to Supplementary note 4, wherein
the information is video information about inside of the vehicle,
the analysis means analyzes, as the state of the vehicle, an emergency degree of an action of a passenger inside the recognized vehicle and a state of the passenger, and
the specifying means specifies the control policy as a remote control policy when the emergency degree is greater than or equal to a threshold value.

### Supplementary Note 7

The traffic control apparatus according to Supplementary note 4, wherein
the vehicle is a bus;
the information is video information of the inside of the vehicle,
the analysis means analyzes the passenger inside the vehicle and a posture of the passenger as the state of the vehicle, and
the specifying means specifies the control policy as a remote control policy when the passenger is a predetermined person prone to fall or the posture of the passenger is a posture in which the passenger is prone to fall.

### Supplementary Note 8

A traffic control system comprising:
a vehicle including an autonomous driving function;
a traffic control center configured to remotely control the vehicle, wherein
the vehicle comprises:
   a sensor configured to detect information about the vehicle; and
   vehicle control means for controlling autonomous driving of the vehicle based on the information detected by the sensor, and
the traffic control center comprises:
   analysis means for analyzing a state of the vehicle based on the information received from the vehicle via a network;
   specifying means for specifying a control policy based on the analyzed state of the vehicle, the control policy being predetermined control to be transmitted to the vehicle; and
   remote control means for controlling driving of the vehicle based on the specified control policy.

### Supplementary Note 9

The traffic control system according to Supplementary note 8, wherein
the analysis means comprises traffic control side learning means for learning an analysis rule for analyzing the state of the vehicle based on the information, and
the specifying means specifies the control policy based on the state of the vehicle analyzed in accordance with the analysis rule.

### Supplementary Note 10

The traffic control system according to Supplementary note 9, wherein
the vehicle control means includes vehicle-side learning means for learning an autonomous driving rule for controlling the autonomous driving based on the information, and
the specifying means specifies the control policy based on the analysis rule and the state of the vehicle analyzed in accordance with the autonomous driving rule.

### Supplementary Note 11

The traffic control system according to any one of Supplementary note 8 to 10, wherein
the control policy includes an autonomous control policy for causing the vehicle to be autonomously driven and a remote control policy for remotely controlling the vehicle, and
when the specified control policy is the autonomous control policy, the remote control means controls the vehicle to be driven autonomously, while when the specified control policy is the remote control policy, the remote control means remotely controls the vehicle.

### Supplementary Note 12

The traffic control system according to Supplementary note 11, wherein
the information is video information about an area in front of the vehicle,
the analysis means analyzes, as the state of the vehicle, a risk degree of a collision with a recognized peripheral vehicle or a recognized peripheral person in a traffic environment including a recognized road and a recognized intersection, and
the specifying means specifies the control policy as a remote control policy when the risk degree is greater than or equal to a threshold value.

### Supplementary Note 13

The traffic control system according to Supplementary note 11, wherein
the information is video information about inside of the vehicle,
the analysis means analyzes, as the state of the vehicle, a state of an emergency degree of an action of a passenger inside the vehicle and a state of the passenger, and
the specifying means specifies the control policy as a remote control policy when the emergency degree is greater than or equal to a threshold value.

### Supplementary Note 14

The traffic control system according to Supplementary note 11, wherein
the vehicle is a bus,
the information is video information of the inside of the vehicle,
the analysis means analyzes the passenger inside the vehicle and a posture of the passenger as the state of the vehicle, and
the specifying means specifies the control policy as a remote control policy when the passenger is a predetermined person prone to fall or the posture of the passenger is a posture in which the passenger is prone to fall.

### Supplementary Note 15

A traffic control method comprising:
analyzing a state of a vehicle based on information about the vehicle including an autonomous driving function;
specifying a control policy based on the analyzed state of the vehicle, the control policy being predetermined control to be transmitted to the vehicle; and
controlling driving of the vehicle based on the specified control policy.

### Supplementary Note 16

The traffic control method according to Supplementary note 15, wherein
in the analyzing of the state of the vehicle, an analysis rule for analyzing the state of the vehicle is learned based on the information, and
in the specifying of the control policy, the control policy is specified based on the state of the vehicle analyzed in accordance with the analysis rule.

### Supplementary Note 17

The traffic control method according to Supplementary note 16, wherein
vehicle-side learning means provided in the vehicle is made to learn an autonomous driving rule for controlling the autonomous driving of the vehicle based on the information, and
in the specifying of the control policy, the control policy is specified based on the analysis rule and the state of the vehicle analyzed in accordance with the autonomous driving rule.

### Supplementary Note 18

The traffic control method according to any one of Supplementary notes 15 to 17, wherein
the control policy includes an autonomous control policy for causing the vehicle to be autonomously driven and a remote control policy for remotely controlling the vehicle, and
in the controlling of the driving of the vehicle, when the specified control policy is the autonomous control policy, the vehicle is controlled to be driven autonomously, while when the specified control policy is the remote control policy, the vehicle is remotely controlled.

### Supplementary Note 19

The traffic control method according to Supplementary note 18, wherein
the information is video information about an area in front of the vehicle,
in the analyzing of the state of the vehicle, a risk degree of a collision with a recognized peripheral vehicle or a recognized peripheral person in a traffic environment including a recognized road and a recognized intersection is analyzed as the state of the vehicle, and
in the specifying of the control policy, the control policy is specified as a remote control policy when the risk degree is greater than or equal to a threshold value.

### Supplementary Note 20

The traffic control method according to Supplementary note 18, wherein
the information is video information about inside of the vehicle,
in the analyzing of the state of the vehicle, a state of an emergency degree of an action of a passenger inside the vehicle and a state of the passenger are analyzed as the state of the vehicle, and
in the specifying of the control policy, the control policy is specified as a remote control policy when the emergency degree is greater than or equal to a threshold value.

### Supplementary Note 21

The traffic control method according to Supplementary note 18, wherein
the vehicle is a bus,
the information is video information of the inside of the vehicle,
in the analyzing of the state of the vehicle, the passenger inside the vehicle and a posture of the passenger are analyzed as the state of the vehicle, and
in the analyzing of the control policy, the control policy is specified as a remote control policy when the passenger is a predetermined person prone to fall or the posture of the passenger is a posture in which the passenger is prone to fall.

### Supplementary Note 22

A non-transitory computer readable medium storing a program for causing a computer to execute:
analyzing a state of a vehicle based on information about the vehicle including an autonomous driving function;
specifying a control policy based on the analyzed state of the vehicle, the control policy being predetermined control to be transmitted to the vehicle; and
controlling driving of the vehicle based on the specified control policy.

### Supplementary Note 23

A non-transitory computer readable medium storing the program according to Supplementary note 22 for causing the computer to execute:
in the analyzing of the state of the vehicle, learning an analysis rule for analyzing the state of the vehicle based on the information, and
in the specifying of the control policy, specifying the control policy based on the state of the vehicle analyzed in accordance with the analysis rule.

### Supplementary Note 24

A non-transitory computer readable medium storing the program according to Supplementary note 23 for causing the computer to execute:
vehicle-side learning means provided in the vehicle is made to learn an autonomous driving rule for controlling the autonomous driving of the vehicle based on the information, and
in the specifying of the control policy, specifying the control policy based on the analysis rule and the state of the vehicle analyzed in accordance with the autonomous driving rule.

### Supplementary Note 25

A non-transitory computer readable medium storing the program according to any one of Supplementary notes 22 to 24, wherein
the control policy includes an autonomous control policy for causing the vehicle to be autonomously driven and a remote control policy for remotely controlling the vehicle, and
the program further causes the computer to execute:
in the controlling of the driving of the vehicle, when the specified control policy is the autonomous control policy, controlling the vehicle to be driven autonomously, while when the specified control policy is the remote control policy, remotely controlling the vehicle.

### Supplementary Note 26

A non-transitory computer readable medium storing the program according to Supplementary note 25, wherein
the information is video information about an area in front of the vehicle, and
the program further causes the computer to execute:
in the analyzing of the state of the vehicle, analyzing a risk degree of a collision with a recognized peripheral vehicle or a recognized peripheral person in a traffic environment including a recognized road and a recognized intersection as the state of the vehicle, and
in the specifying of the control policy, specifying the control policy as a remote control policy when the risk degree is greater than or equal to a threshold value.

### Supplementary Note 27

A non-transitory computer readable medium storing the program according to Supplementary note 25, wherein
the information is video information about inside of the vehicle, and
the program further causes the computer to execute:
in the analyzing of the state of the vehicle, analyzing a state of an emergency degree of an action of a passenger inside the vehicle and a state of the passenger as the state of the vehicle, and
in the specifying of the control policy, specifying the control policy as a remote control policy when the emergency degree is greater than or equal to a threshold value.

### Supplementary Note 28

A non-transitory computer readable medium storing the program according to Supplementary note 25, wherein
the vehicle is a bus, and
the information is video information of the inside of the vehicle,
the program further causes the computer to execute:
in the analyzing of the state of the vehicle, analyzing the passenger inside the vehicle and a posture of the passenger as the state of the vehicle, and
in the analyzing of the control policy, specifying the control policy as a remote control policy when the passenger is a predetermined person prone to fall or the posture of the passenger is a posture in which the passenger is prone to fall.

In the above example, the above program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W (Read Only Memory), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### REFERENCE SIGNS LIST

100, 200 TRAFFIC CONTROL SYSTEM
110, 210 VEHICLE
111, 211 SENSOR
112, 212 VEHICLE CONTROL UNIT
120, 220 TRAFFIC CONTROL APPARATUS
120c, 220c TRAFFIC CONTROL CENTER
121, 221 ANALYSIS UNIT
122, 222 SPECIFYING UNIT
123, 223 REMOTE CONTROL UNIT
213, 224 LEARNING DEVICE
NW NETWORK

1. A vehicle including an autonomous driving function comprising:
at least one memory storing instructions, and
at least one processor configured to execute the instructions to:
control an autonomous driving of the vehicle based on information about the vehicle;
analyze, based on the information, a first state of the vehicle by a first analyzer relating to the autonomous driving of the vehicle;
transmit the information to a control apparatus located outside of the vehicle via a network; and
control the autonomous driving of the vehicle based on the first state and a second state analyzed by a second analyzer different from the first analyzer, wherein the second analyzer analyzes the second state based on the information received from the vehicle in the control apparatus.

2. The vehicle according to claim 1, wherein the first analyzer analyzes the first state by an autonomous driving rule relating to the autonomous driving of the vehicle, the autonomous driving rule being generated by learning the information.

3. The vehicle according to claim 2, wherein the second analyzer analyzes the second state by an analysis rule different from the autonomous driving rule, the analysis rule being generated by learning the information.

4. The vehicle according to claim 1, wherein
the information detected by the vehicle is about an area in front of the vehicle, and
a state of a peripheral vehicle or a state of a peripheral person in the area including a road is analyzed as the second state of the vehicle.

5. The vehicle according to claim 4, wherein
a potential to collide with the peripheral vehicle or the peripheral person is analyzed as the second state of the vehicle.

6. The vehicle according to claim 4, wherein
the first analyzer further analyzes the state of the peripheral vehicle or the state of the peripheral person by an autonomous driving rule relating to the autonomous driving of the vehicle, the autonomous driving rule being different from an analysis rule by which the second analyzer analyzes the state of the peripheral vehicle or the state of the peripheral person.

7. A control system comprising:
a vehicle including an autonomous driving function;
a control apparatus placed outside of the vehicle and configured to communicate with the vehicle via a network, wherein
the vehicle comprises at least one memory storing instructions, and at least one processor configured to execute the instructions to:
control an autonomous driving of the vehicle based on information about the vehicle; and
analyze, based on the information, a first state of the vehicle by a first analyzer relating to the autonomous driving of the vehicle, and
the control apparatus comprises at least one memory storing instructions, and at least one processor configured to execute the instructions to:
analyze, based on the information received from the vehicle, a second state of the vehicle by a second analyzer different from the first analyzer wherein
the at least one processor of the vehicle is configured to execute the instructions to control the autonomous driving of the vehicle based on the first state and the second state.

8. The control system according to claim 7, wherein the first analyzer analyzes the first state by an autonomous driving rule relating to the autonomous driving of the vehicle, the autonomous driving rule being generated by learning the information.

9. The control system according to claim 8, wherein the second analyzer analyzes the second state by an analysis rule different from the autonomous driving rule, the analysis rule being generated by learning the information.

10. The control system according to claim 7, wherein
the information detected by the vehicle is about an area around the vehicle, and
the at least one processor of the control apparatus executes the instructions to:
analyze, as the second state of the vehicle, a state of a peripheral vehicle or a state of a peripheral person in the area including a road.

11. The control system according to claim 10, wherein
the at least one processor of the control apparatus executes the instructions to:
analyze, as the second state of the vehicle, a potential to collide with the peripheral vehicle or the peripheral person.

12. The control system according to claim 10, wherein
the first analyzer further analyzes the state of the peripheral vehicle or the state of the peripheral person by an autonomous driving rule relating to the autonomous driving of the vehicle, the autonomous driving rule being different from an analysis rule by which the second analyzer analyzes the state of the peripheral vehicle or the state of the peripheral person.

13. A control method comprising:
controlling an autonomous driving of a vehicle based on information about the vehicle;
analyzing, based on the information, a first state of the vehicle by a first analyzer relating to the autonomous driving of the vehicle;
transmitting the information to a control apparatus located outside of the vehicle via a network; and
controlling the autonomous driving of the vehicle based on the first state and a second state analyzed by a second analyzer different from the first analyzer, wherein the second analyzer analyzes the second state based on the information received from the vehicle in the control apparatus.

14. The control method according to claim 13, wherein
the first analyzer analyzes the first state by an autonomous driving rule relating to the autonomous driving of the vehicle, the autonomous driving rule being generated by learning the information.

15. The control method according to claim 14, wherein
the second analyzer analyzes the second state by an analysis rule different from the autonomous driving rule, the analysis rule being generated by learning the information.

16. The control method according to claim 13, wherein
the information detected by the vehicle is about an area around the vehicle,
in the analyzing of the second state of the vehicle, a state of a peripheral vehicle or a state of a peripheral person in the area including a road is analyzed.

17. The control method according to claim 16, wherein
in the analyzing of the second state of the vehicle, a potential to collide with the peripheral vehicle or the peripheral person is analyzed.

18. The control method according to claim 16, wherein
the first analyzer further analyzes the state of the peripheral vehicle or the state of the peripheral person by an autonomous driving rule relating to the autonomous driving of the vehicle, the autonomous driving rule being different from an analysis rule by which the second analyzer analyzes the state of the peripheral vehicle or the state of the peripheral person.
